(19) United States
(12) Patent Application Publication
(10) Pub. No.: US 2023/0246246 A1
(43) Pub. Date: Aug. 3, 2023

(54) WOUND ELECTRODE ASSEMBLY, BATTERY, AND MANUFACTURING METHOD OF WOUND ELECTRODE ASSEMBLY

(71) Applicant: Prime Planet Energy & Solutions, Inc., Tokyo (JP)

(72) Inventors: Yuko NOWATARI, Kasai-shi (JP); Atsushi OBAYASHI, Sumoto-shi (JP); Hideo KUSADA, Osaka-shi (JP); Koji NIHOMMATSU, Sumoto-shi (JP)

(21) Appl. No.: 18/159,093

(22) Filed: Jan. 25, 2023

(30) Foreign Application Priority Data
Jan. 28, 2022 (JP) 2022-011516

(51) Int. Cl. H01M 10/0587; H01M 50/46

(52) U.S. Cl. CPC H01M 10/0587; H01M 50/461

(57) ABSTRACT

The disclosed flat-shaped wound electrode assembly includes a negative electrode, a positive electrode, a first separator, and a second separator. They are stacked one on another to arrange the first separator between the negative electrode and the positive electrode, and to arrange the second separator on the outermost surface of the wound electrode assembly. The resultant is wound around a winding axis in a longitudinal direction. On each of both main surfaces of the first separator and both main surfaces of the second separator, an adhesion layer is located in stripe patterns. When viewed from a flat side surface of the wound electrode assembly, in a predetermined direction, an angle of the adhesion layer of the first separator with respective to the winding axis on the main surface and an angle of the adhesion layer of the second separator with respect to the winding axis are different from each other.

### CROSS REFERENCE TO RELATED APPLICATIONS

The present application claims the priority based on Japanese Patent Application No. 2022-11516 filed on Jan. 28, 2022, and the entire contents of that application are incorporated in the present specification by reference.

### BACKGROUND

The present disclosure relates to a wound electrode assembly, a battery, and a manufacturing method of a wound electrode assembly.

An electrode assembly used for a secondary battery, such as a lithium ion secondary battery, generally includes a positive electrode and a negative electrode that are insulated by a separator. For example, Publication of Japanese Patent Application 2011-512005 discloses a separator that includes a dot pattern layer formed with multiple dots spaced away to each other by predetermined intervals, while the multiple dots are formed with binding property polymers. The separator including the above-described configuration is concluded to enhance the binding property between the electrodes and the separator. In addition, for example, Publication of Japanese Patent Application 2014-509777 discloses a separator that includes a porous coating layer on which a pattern layer of a groove for making the electrolyte infiltrate is formed.

### SUMMARY

Anyway, the present inventor is considering to apply a separator, which includes an adhesion layer having stripe patterns with predetermined pitches, to the wound electrode assembly, in order to stabilize an electrode plate distance of the positive and negative electrodes. However, since 2 sheets of separators are generally used in the wound electrode assembly, it causes an area on which a recessed part and another recessed part of the stripe patterns of 2 sheets of separators are overlapped to each other and an area on which a protruding part and another protruding part of the stripe patterns of 2 sheets of separators are overlapped to each other. Thus, when a confining pressure is applied on the wound electrode assembly, a difference in reaction forces of the portion on which the recessed parts are overlapped to each other and the portion on which the protruding parts are overlapped to each other becomes larger and then a variation in the reaction forces becomes larger. As the result, it causes a problem that appropriate adjustment on the confining pressure of the battery becomes difficult.

Then, the present disclosure has been made in view of the above-described circumstances, and a main object is to provide a wound electrode assembly that may mitigate the variation in the reaction forces for the confining pressure. In addition, another object is to provide a battery including the above-described wound electrode assembly. Furthermore, another object is to provide a manufacturing method of the above-described wound electrode assembly.

A flat-shaped wound electrode assembly disclosed herein wound electrode assembly and includes an elongated negative electrode, an elongated positive electrode, an elongated first separator, and an elongated second separator. The negative electrode, the positive electrode, the first separator, and the second separator are stacked and wound around a winding axis in a longitudinal direction. The first separator is arranged between the negative electrode and the positive electrode. The second separator is arranged on an outermost surface of the wound electrode assembly. On each of both main surfaces of the first separator and both main surfaces of the second separator, an adhesion layer is located in stripe patterns with predetermined pitches. When viewed from a flat side surface of the wound electrode assembly, an angle of the adhesion layer of the first separator in a predetermined direction of the winding axis direction with respect to the winding axis on the main surface of the first separator is different from an angle of the adhesion layer of the second separator in the predetermined direction of the winding axis direction with respect to the winding axis on the main surface of the second separator opposed to the main surface of the first separator and sandwiching the negative electrode or the positive electrode with the main surface of the first separator.

By including the configuration as described above, in a point of view from a flat side surface of the wound electrode assembly, the overlap areas can be dotted regularly on which the adhesion layer not-formed area (recessed part) of the main surface of the first separator and the adhesion layer not-formed area (recessed part) of the main surface of the second separator opposed to the main surface and sandwiching the positive electrode or the negative electrode with the main surface, and thus it is possible to mitigate the variation in the reaction forces with respect to the confining pressure.

In one aspect of the herein disclosed wound electrode assembly, a difference between the angle of the adhesion layer of the first separator with respect to the winding axis and the angle of the adhesion layer of the second separator with respect to the winding axis is equal to or more than 40° and not more than 140°. By including the configuration as described above, it is possible to make each area size of areas on which the adhesion layer not-formed area is overlapping be smaller so as to further mitigate the variation in the reaction forces with respect to the confining pressure.

In one aspect of the herein disclosed wound electrode assembly, each of a rate of the main surface of the first separator covered by the adhesion layer and a rate of the main surface of the second separator covered by the adhesion layer is equal to or more than 50% and not more than 90%. By including this, it is possible to make the area size of the whole of overlap area on which the adhesion layer not-formed area is overlapping be smaller so as to further mitigate the variation in the reaction forces with respect to the confining pressure.

In addition, the present disclosure provides a battery including the herein disclosed wound electrode assembly. The battery including the wound electrode assembly may mitigate a variation in reaction forces with respect to confining pressures, and thus the adjustment on the confining pressure becomes easy.

In addition, the present disclosure provides a manufacturing method of the herein disclosed wound electrode assembly. One aspect of the herein disclosed wound electrode assembly manufacturing method includes a preparation step and a winding step. The preparation step is for preparing an elongated first separator that includes an adhesion layer located on both main surfaces in stripe patterns with predetermined pitches, and an elongated second separator that includes an adhesion layer located on both main surfaces in stripe patterns with predetermined pitches. The winding step is for stacking an elongated negative electrode, an elongated positive electrode, the first separator, and the second separator to arrange the first separator between the negative electrode and the positive electrode and to arrange the second separator on an outermost layer and winding the resultant (the stack) around a winding axis in a longitudinal direction. Furthermore, the winding step includes stacking the negative electrode, the positive electrode, the first separator, and the second separator so as to make an angle of an adhesion layer of the first separator with respect to a predetermined direction of a width direction orthogonal to a longitudinal direction of the first separator on a main surface of the first separator difference from an angle of an adhesion layer of the second separator with respect to the predetermined direction on a main surface of the second separator that is opposed to the main surface of the first separator and sandwiches the negative electrode or the positive electrode with the main surface of the first separator.

Additionally, in one aspect of the herein disclosed wound electrode assembly manufacturing method, the stripe pattern of the first separator and the stripe pattern of the second separator are the same. By making the stripe pattern of the first separator and the stripe pattern of the second separator be the same, it is possible to reduce the manufacture cost of the separators.

### BRIEF DESCRIPTION OF THE DRAWINGS

FIG. 1 is an exploded view that schematically shows a configuration of a wound electrode assembly in accordance with one embodiment.

FIG. 2 is a schematic view in which a configuration of a main surface of a first separator included by the wound electrode assembly in accordance with one embodiment is viewed from a direction perpendicular to a main surface of the first separator.

FIG. 3 is a partial cross section view that schematically shows an example of the configuration of the first separator included by the wound electrode assembly in accordance with one embodiment.

FIG. 4 is a partially enlarged view that is for explaining an example of a stripe pattern of an adhesion layer of the first separator included by the wound electrode assembly in accordance with one embodiment.

FIG. 5 is a partially enlarged view that is for explaining an example of a stripe pattern of an adhesion layer of a second separator included by the wound electrode assembly in accordance with one embodiment.

FIG. 6 is a view that schematically shows an overlap of the stripe pattern of the main surface of the first separator and the stripe pattern of the main surface of the second separator opposed to each other and sandwiching a positive electrode or a negative electrode, viewed from a flat side surface of the wound electrode assembly in accordance with one embodiment.

FIG. 7 is a schematic view that shows an example of a configuration of a winding apparatus used in a manufacturing method of the wound electrode assembly in accordance with one embodiment.

FIG. 8 is a cross section view that schematically shows a configuration of a nonaqueous electrolyte secondary battery in accordance with one embodiment.

### DETAILED DESCRIPTION

Below, the herein disclosed technique will be described in details. The matter required for implementing, even though matters other than matters particularly mentioned in this specification, can be grasped as design matters of those skilled in the art based on the related art in the present field. The content of the herein disclosed technique can be executed based on the contents disclosed in the present specification, and the technical common sense in the present field.

Incidentally, each figure is schematically shown, and thus the dimensional relation (such as a length, a width, or a thickness) does not always reflect the actual dimensional relation. Additionally, in the figures explained below, the members/parts providing the same effect are provided with the same numerals and signs, and an overlapping explanation might be omitted or simplified.

Additionally, in the present specification, when a numerical value range is represented by “A to B (here, A and B are arbitrary numerical values)”, it means “equal to or more than A and not more than B” and semantically covers “more than A and less than B”, “more than A and not more than B”, and “equal to or more than A and less than B”.

A wound electrode assembly 20 herein disclosed can be suitably used for a battery, such as a primary battery and a secondary battery. Incidentally, in the present specification, “battery” is a term widely denoting an electric storage device capable of taking out an electric energy. In addition, the term “secondary battery” widely denotes an electric storage device capable of repeatedly charging and discharging, and semantically covers a capacitor (i.e., a physical battery) such as an electric double layer capacitor, in addition to a so-called storage battery such as a lithium ion secondary battery, a nickel hydrogen battery, and a nickel cadmium battery (i.e., a chemical battery). Below, as for one embodiment of the wound electrode assembly 20, a configuration of the wound electrode assembly 20 used in the lithium ion secondary battery will be described.

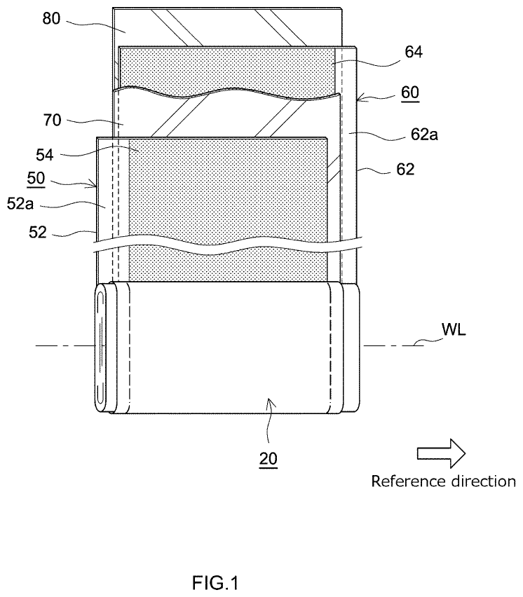

FIG. 1 is an exploded view that schematically shows the configuration of the wound electrode assembly 20 in accordance with one embodiment. As shown in FIG. 1, the wound electrode assembly 20 includes a positive electrode 50, a negative electrode 60, a first separator 70, and a second separator 80. The wound electrode assembly 20 is, for example, formed in a flat shape. In the present embodiment, each of the positive electrode 50, the negative electrode 60, the first separator 70, and the second separator 80 is formed in a long sheet shape (an elongated sheet shape). The first separator 70 is arranged between the positive electrode 50 and the negative electrode 60, and insulates the positive electrode 50 and the negative electrode 60. In addition, the second separator 80 is arranged to be the outermost surface of the wound electrode assembly 20. The present embodiment is formed by stacking the second separator 80, the negative electrode 60, the first separator 70, and the positive electrode 50 in this order to align these ends in the longitudinal direction, so as to make the resultant be wound therein in the longitudinal direction with a winding axis WL being treated as a center. Incidentally, the order of them for stacking one on another is not particularly restricted, and thus, for example, the second separator 80, the positive electrode 50, the first separator 70, and the negative electrode 60 might be stacked in this order.

The positive electrode 50 includes a positive electrode current collector 52, and a positive electrode mixing agent layer 54 that is formed on one surface or both surfaces (herein, both surfaces) of the positive electrode current collector 52 in the longitudinal direction. On an edge part at one side of the positive electrode current collector 52 in the winding axis WL direction (in other words, sheet width direction orthogonal to the longitudinal direction), a portion (in other words, positive electrode current collector exposed part 52a) is provided on which the positive electrode current collector 52 is exposed in a strip-like shape along the edge part as the positive electrode mixing agent layer 54 is not formed.

As the positive electrode current collector 52 configuring the positive electrode 50, for example, it is possible to use an aluminum foil, or the like. The positive electrode mixing agent layer 54 contains a positive electrode active substance. As the positive electrode active substance, a well-known positive electrode active substance used for the lithium ion secondary battery can be used, and, for example, it is possible to use lithium composite metal oxide (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄, LiCrMnO₄, LiFePO₄, or the like) including a layer-like structure, a spinel structure, an olivine structure, or the like. In addition, the positive electrode mixing agent layer 54 might contain an electrical conducting material, a binder, or the like. As the electrical conducting material, for example, a carbon black, such as acetylene black (AB), or the other carbon material (graphite, or the like) can be suitably used. As the binder, for example, polyvinylidene fluoride (PVdF), or the like, can be used.

The positive electrode mixing agent layer 54 can be formed by dispersing a positive electrode active substance and a material used as needed (electrical conducting material, binder, or the like) into a suitable solvent (e.g., N-methyl-2-pyrrolidone: NMP), by preparing a paste-like (or slurry-like) composition, by coating the surface of the positive electrode current collector 52 with a suitable amount of this composition, and then by drying the resultant.

The negative electrode 60 includes a negative electrode current collector 62 and a negative electrode mixing agent layer 64 that is formed on one surface or both surfaces (herein, both surfaces) of the negative electrode current collector 62 in the longitudinal direction. On an edge part at a side opposite to one side of the negative electrode current collector 62 in the winding axis WL direction, a portion (in other words, negative electrode current collector exposed part 62a) is provided on which the negative electrode current collector 62 is exposed in a strip-like shape along the edge part as the negative electrode mixing agent layer 64 is not formed.

As the negative electrode current collector 62 configuring the negative electrode 60, for example, it is possible to use a copper foil, or the like. The negative electrode mixing agent layer 64 contains a negative electrode active substance. As the negative electrode active substance, for example, a carbon material, such as graphite, hard carbon, and soft carbon, can be used. In addition, the negative electrode mixing agent layer 64 might further contain a binder, a thickening agent, or the like. As the binder, for example, styrene butadiene rubber (SBR), or the like, can be used. As the thickening agent, for example, carboxymethyl cellulose (CMC), or the like, can be used.

The negative electrode mixing agent layer 64 can be formed, for example, by dispersing a negative electrode active substance and a material used as needed (binder, or the like) into a suitable solvent (e.g., ion exchange water), by preparing a paste-like (or slurry-like) composition, by coating the surface of the negative electrode current collector 62 with a suitable amount of this composition, and then by drying the resultant.

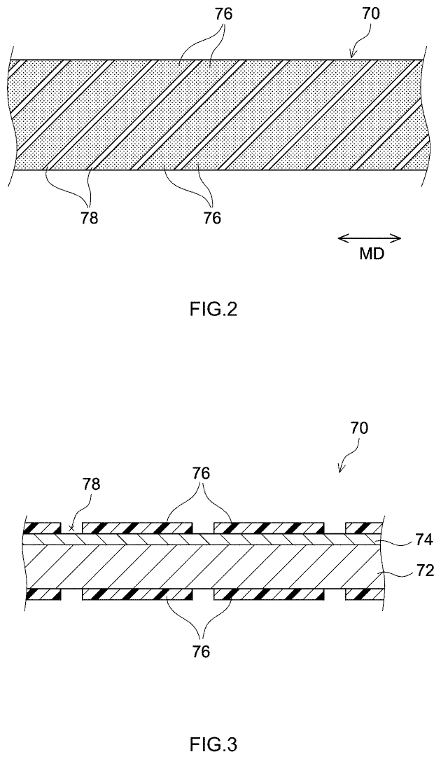

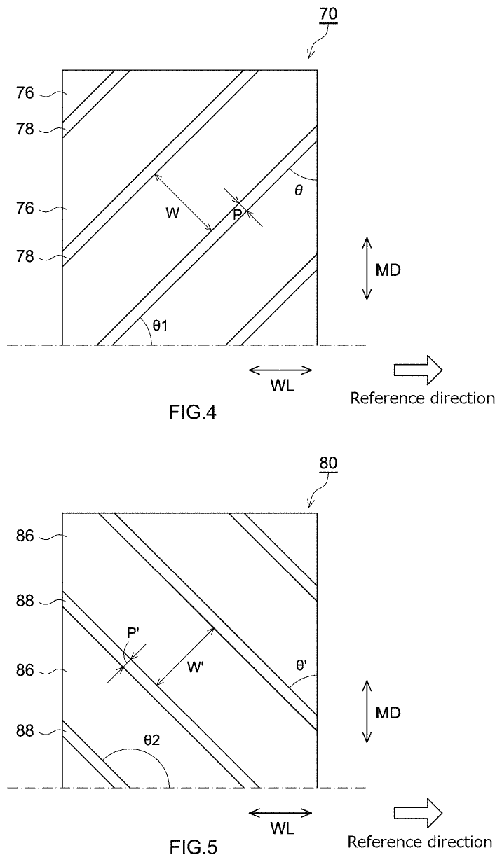

An example of the first separator 70 is shown in FIGS. 2 to 4. FIG. 2 is a schematic view that schematically shows an example of a configuration of the first separator 70. FIG. 2 is a schematic view in which a configuration of a main surface of the first separator 70 is viewed from a direction perpendicular to the main surface. FIG. 3 is a partial cross section view that schematically shows an example of the configuration of the first separator 70. FIG. 4 is a partially enlarged view that is for explaining an example of a stripe pattern of an adhesion layer 76 of the first separator 70.

Regarding the example shown in FIGS. 2 to 4, the first separator 70 includes a base material layer 72 made from a porous resin, and includes the adhesion layer 76 provided with an adhesion component. In addition, regarding the example, the first separator 70 further includes a ceramic layer 74 that contains an inorganic particle. However, the ceramic layer 74 might be not provided. A MD direction shown by an arrow in the figure is a longitudinal direction of the first separator 70, and the main surface of the first separator 70 includes long sides parallel to the MD direction. Incidentally, regarding the separator formed in the sheet shape, the main surface is a wide-width surface of the sheet.

The porous resin configuring the base material layer 72 might be a well-known porous resin used for a separator of a nonaqueous electrolyte secondary battery. As an example of the resin, it is possible to use polyolefin, polyester, cellulose, polyamide, or the like. Among them, the polyolefin is preferable because the polyolefin can provide a so-called shutdown function to the first separator 70. As a suitable example of the polyolefin, it is possible to use polyethylene (PE), polypropylene (PP), or the like.

The base material layer 72 might consist of a single-layer structure, or a laminate structure configured with two or more layers (for example, triple-layer structure in which PP layers are laminated on both surfaces of a PE layer).

A thickness of the base material layer 72 is not particularly restricted if it satisfies a condition that the positive electrode and the negative electrode are insulated, and the thickness is, for example, equal to or more than 8 μm and not more than 40 μm, preferably equal to or more than 10 μm and not more than 25 μm, or further preferably equal to or more than 10 μm and not more than 14 μm.

A porosity of the base material layer 72 is not particularly restricted, and might be similar to a porosity of a well known base material layer of the separator of the nonaqueous electrolyte secondary battery. The porosity of the base material layer 72 is, for example, equal to or more than 20% and not more than 70%, preferably equal to or more than 30% and not more than 60%, or further preferably equal to or more than 40% and not more than 50%. Incidentally, the porosity of the base material layer 72 can be measured by a mercury penetration method.

An air permeability of the base material layer 72 is not particularly restricted, and might be similar to that of a well-known base material layer of the separator of the nonaqueous electrolyte secondary battery. The air permeability of the base material layer 72 is, for example, equal to or more than 50 second/100 mL and not more than 600 second/100 mL, or preferably equal to or more than 150 second/100 mL and not more than 300 second/100 mL, as a Gurley value. Incidentally, the Gurley value of the base material layer 72 can be measured by a method defined by JIS-P8117(2009).

A kind of the inorganic particle contained in the ceramic layer 74 is not particularly restricted. As an example of the inorganic particle, it is possible to use a particle of oxide-based ceramics, such as alumina (Al₂O₃), silica (SiO₂), titania (TiO₂), zirconia (ZrO₂), magnesia (MgO), ceria (CeO₂), and zinc oxide (ZnO); a particle of nitride-based ceramics, such as silicon nitride, titanium nitride, and boron nitride; a particle of metal hydroxide, such as calcium hydroxide, magnesium hydroxide, and aluminum hydroxide; a particle of clay mineral, such as mica, talc, boehmite, zeolite, apatite, and kaolin; a particle of sulfate, such as sulfuric acid barium, and sulfuric acid strontium; a glass fiber; or the like. Among them, particles of alumina and boehmite are preferable. Alumina and boehmite have a higher melting point and have a superior heat resistance. In addition, alumina and boehmite have a comparatively higher Mohs hardness, and have a superior mechanical strength and durability. Furthermore, alumina and boehmite are comparatively inexpensive, and thus it is possible to suppress the raw material cost.

A shape of the inorganic particle is not particularly restricted, and might be spherical or non-spherical. An average particle diameter (D₅₀) of the inorganic particle is not particularly restricted, and is, for example, equal to or more than 0.1 μm and not more than 5 μm, preferably equal to or more than 0.3 μm and not more than 3 μm, or further preferably equal to or more than 0.5 μm and not more than 1.5 μm. Incidentally, in the present specification, the average particle diameter (D₅₀) is a median diameter (D₅₀), and therefore means a particle diameter corresponding to cumulative frequency 50 volume % from a microparticle side whose particle diameter is smaller on a volume basis particle size distribution based on a laser diffraction and scattering method. Thus, the average particle diameter (D₅₀) can be obtained with a well-known laser diffraction and scattering type of particle size distribution measuring apparatus, or the like.

The ceramic layer 74 might contain a component other than the inorganic particle, and, as its example, it is possible to use a binder, a thickening agent, or the like. As an example of the binder, it is possible to use a fluorine type polymer, such as polytetrafluoroethylene (PTFE) and polyvinylidene fluoride (PVdF); an acrylic binder; a rubber type binder, such as styrene butadiene rubber (SBR); a polyolefin type binder; or the like. As an example of the thickening agent, it is possible to use carboxymethyl cellulose (CMC), methyl cellulose (MC), or the like.

A content amount of the inorganic particle in the ceramic layer 74 is not particularly restricted, but is preferably equal to or more than 80 mass %, or further preferably equal to or more than 90 mass % and not more than 97 mass %. A content amount of the binder in the ceramic layer 74 is not particularly restricted, but is preferably equal to or more than 3 mass % and not more than 10 mass %, or further preferably equal to or more than 3 mass % and not more than 8 mass %.

A thickness of the ceramic layer 74 is not particularly restricted, and for example, is equal to or more than 0.3 μm and not more than 6.0 μm, preferably equal to or more than 0.5 μm and not more than 4.5 μm, or further preferably equal to or more than 1.0 μm and not more than 2.0 μm.

A porosity of the ceramic layer 74 is not particularly restricted, and might be similar to a well-known ceramic layer 74 of the separator of the nonaqueous electrolyte secondary battery. The porosity of the ceramic layer 74 is, for example, equal to or more than 30% and not more than 90%, preferably equal to or more than 40% and not more than 80%, or furthermore preferably equal to or more than 50% and not more than 70%. Incidentally, the porosity of the ceramic layer 74 can be measured by a mercury penetration method.

Incidentally, in illustrations of figures, the first separator 70 includes the ceramic layer 74 only on one of the main surfaces of the base material layer 72. However, the first separator 70 might includes the ceramic layers 74 on both main surfaces of the base material layer 72.

The adhesion layer 76 is provided on at least one of the main surfaces of the first separator 70. In illustrations of FIGS. 2 to 4, the first separator 70 includes adhesion layers 76 on both main surfaces (in other words, main surface at the base material layer 72 side and main surface at the ceramic layer 74 side). Because of this, it is possible to enhance an adhesive property of the first separator and the positive electrode and negative electrode, so as to stabilize a between-electrode-plates distance which is between the positive and negative electrodes. In addition, regarding the adhesion layer 76, it is sufficient to be provided on a surface layer of the first separator 70. The adhesion layer 76 might be provided on the base material layer 72 or on the ceramic layer 74, or might be provided on a different arbitrary layer.

In the present embodiment, the adhesion layer 76 configures stripe patterns provided with predetermined pitches. Therefore, as shown in figures, the adhesion layer 76 is formed as a protruding part that extends in one direction. Thus, on the main surface of the first separator 70 provided with the adhesion layer 76, an area including the adhesion layer 76 and an adhesion layer not-formed area 78 being an area not including the adhesion layer 76 are alternately formed. The adhesion layer not-formed area 78 exists as a recessed part that extends in one direction. By the configuration as described above, it is possible to enhance an impregnation property for the nonaqueous electrolyte, in addition to enhancement in the adhesive property of the first separator 70 and the electrode (positive electrode and negative electrode). In detail, a flow channel of the nonaqueous electrolyte is formed on the adhesion layer not-formed area 78, and thus it facilitates impregnating to an inside of the wound electrode assembly 20 with the nonaqueous electrolyte. Incidentally, in consideration of a technical limit for the manufacture, it is allowed that a slight adhesion component sticks on the adhesion layer not-formed area 78 (for example, a covered rate of the adhesion component on the adhesion layer not-formed area 78 is equal to or less than 5%, or preferably equal to or less than 1%).

In illustrations of figures, positions of the adhesion layers 76 on both main surfaces of the first separator 70 is formed to correspond to each other. In other words, as shown in FIG. 3, the positions of the adhesion layers 76 on both main surfaces coincide with each other in a thickness direction of the first separator 70, and furthermore, positions of the adhesion layer not-formed areas 78 on both main surfaces coincide with each other. However, the present disclosure is not restricted to this, positions at the adhesion layer not-formed areas 78 on both main surfaces of the first separator 70 in a suitable example do not correspond to each other, and, for example, the adhesion layer 76 is included in which respective main surfaces consist of different stripe patterns. By doing this, an area size of an overlapped portion of the adhesion layer not-formed areas 78 on both main surfaces of the first separator 70 is reduced, and thus it is possible to further mitigate a variation in a reaction force with respect to a confining pressure.

In the present embodiment, the stripe pattern of the adhesion layer 76 is formed as an oblique stripe pattern. An angle defined by the adhesion layer 76 and a long side of the main surface of the first separator 70 (in other words, an angle θ shown in FIG. 4) is not particularly restricted, but is preferably equal to or more than 20° and not more than 70°, further preferably equal to or more than 30° and not more than 65°, or furthermore preferably equal to or more than 45° and not more than 60°. By satisfying a range of this angle, it is possible to further enhance the impregnation property of the wound electrode assembly 20. Incidentally, in a case of the oblique stripe pattern, the angle defined by the adhesion layer 76 and the long side of the main surface of the first separator 70 might be an acute angle or an obtuse angle, but in the present specification, the acute angle is used as for this angle.

Regarding the first separator 70, an angle (in other words, angle θ1 shown in FIG. 4) of the adhesion layer 76 with respect to the winding axis WL direction (in other words, width direction orthogonal to the longitudinal direction) of the first separator 70 is not particularly restricted, but is preferably equal to or more than 20° and not more than 160°, further preferably equal to or more than 45° and not more than 135°, or furthermore preferably equal to or more than 60° and not more than 120°. Incidentally, the angle θ1 as described above is an angle formed in a predetermined direction (here, right side in FIG. 4 (reference direction side in the figure)) among angles defined by the winding axis WL direction and the adhesion layer, and can be a value of 0°<θ1<180°.

Incidentally, the stripe pattern of the adhesion layer 76 is not restricted to the oblique stripe pattern. For example, it might be a stripe pattern parallel to the long side of the main surface of the first separator 70 (in other words, parallel to the longitudinal direction). In addition, it might be a stripe pattern perpendicular to the long side of the main surface of the first separator 70 (in other words, perpendicular to the longitudinal direction). Incidentally, in the present specification, when it is a stripe pattern perpendicular to the long side of the main surface of the first separator 70, the angle θ1 of the adhesion layer 76 with respect to a direction orthogonal to the longitudinal direction of the first separator 70 is 0°.

On the main surface of the first separator 70 where the adhesion layer 76 is formed, a rate of the main surface of the first separator 70 covered by the adhesion layer 76 (in other words, coating area size of the adhesion layer 76 on the main surface of the first separator 70) is not particularly restricted. From a perspective of implementing a higher adhesive property, the rate is preferably equal to or more than 50%, or further preferably equal to or more than 60%. On the other hand, from a perspective of implementing a particularly high impregnation property with the nonaqueous electrolyte and a particularly low battery resistance, the covered rate is preferably equal to or less than 90%, or further preferably equal to or less than 80%.

A width of the adhesion layer 76 (in other words, a size in a direction perpendicular to an extending direction of the adhesion layer 76; size W shown in FIG. 4) is not particularly restricted, but, for example, is equal to or more than 0.5 mm and not more than 4 mm, or preferably equal to or more than 3 mm and not more than 4 mm.

A distance between the adhesion layers 76 (in other words, a width between the adhesion layer not-formed areas 78; size P shown in FIG. 4) is not particularly restricted, but, for example, is equal to or more than 0.5 mm and not more than 4 mm, or preferably equal to or more than 0.5 mm and not more than 2 mm.

A thickness of the adhesion layer 76 (in other words, a size in a direction perpendicular to the main surface of the first separator 70) is not particularly restricted, but, for example, is equal to or more than 0.5 μm and not more than 4.5 μm, preferably equal to or more than 0.5 μm and not more than 2.5 μm, or further preferably equal to or more than 1.0 μm and not more than 2.0 μm.

From a perspective of arranging areas, easily impregnated with the nonaqueous electrolyte, with predetermined intervals so as to make the impregnation property with the nonaqueous electrolyte become higher, it is preferable that the width of the adhesion layer 76 is equal to or more than 0.5 mm and not more than 4 mm and the covered rate of the main surface of the separator by the adhesion layer 76 is equal to or more than 50% and not more than 90%.

Incidentally, regarding an example shown in FIG. 3, the adhesion layer 76 includes a cross section rectangular shape. By making the cross section of the adhesion layer 76 be rectangular, it is easy to obtain a large adhesion area size with the electrode. However, the cross-section shape of the adhesion layer 76 is not restricted to this, if the electrode and the first separator 70 can be adhered.

The adhesion layer 76 contains an adhesion component. A kind of the adhesion component is not particularly restricted if it is possible to adhere the electrode and the first separator 70. The adhesion component is typically an adhesive property resin, and it is possible as the example to use polyvinylidene fluoride (PVdF); a diene-based rubber, such as styrene butadiene rubber (SBR), acrylonitrile-butadiene rubber (NBR), and acrylonitrile-butadiene-styrene rubber (NSBR); (meth)acrylic resin, such as poly acrylic acid, butyl acrylate-ethylhexyl acrylate copolymer, and methyl methacrylate-ethylhexyl acrylate copolymer; a cellulose derivative, such as carboxymethyl cellulose, and hydroxy alkyl cellulose; poly acrylonitrile; polyvinyl chloride; polyvinyl alcohol; polyvinyl butyral; polyvinyl pyrrolidone; or the like. Among these adhesive property resins, the adhesion layer 76 might contain one kind of adhesive property resin or two or more kinds of adhesive property resins. Among them, polyvinylidene fluoride is preferable from perspectives of implementing a higher adhesive property with the separator and the electrode and inhibiting a harmful effect on the battery characteristic.

The adhesion layer 76 might contain only the adhesion component, or might further contain a component in addition to the adhesion component (in other words, the other component). As an example of said the other component, it is possible to use an additive agent, such as an inorganic particle, a defoaming agent, a surfactant, a humectant, and a pH adjusting agent. For example, by making the adhesion layer 76 contain the inorganic particle, it is possible to enhance a heat resistance of the first separator 70. Regarding the inorganic particle, for example, it is possible to use components illustrated as the inorganic particle described above to be contained in the ceramic layer 74. Incidentally, in a case where the adhesion layer 76 contains the inorganic particle, a rate of the inorganic particle on the whole of adhesion layer 76 is equal to or less than 40 wt %, or preferably equal to or less than 30 wt %.

In a case where the adhesion layer 76 contains a component other than the adhesion component, a rate of the adhesion component on the whole of adhesion layer 76 is suitably equal to or more than 60 wt %, or preferably equal to or more than 70 wt %, or might be, for example, equal to or more than 80 wt %, or equal to or more than 90 wt %. By doing this, it is possible to secure the adhesive property of the adhesion layer 76.

In illustrations of figures, the first separator 70 includes only 3 kinds of layers, which are the base material layer 72, the ceramic layer 74, and the adhesion layer 76. However, the first separator 70 might further include a layer in addition to the base material layer 72, the ceramic layer 74, and the adhesion layer 76, within a range where the effect of the present disclosure is not remarkably inhibited.

A configuration of the second separator 80 might be the same as any of configurations illustrated as an embodiment of the above described first separator 70. For example, the first separator 70 and the second separator 80 might be separators including the same configuration. By doing this, it is not required to independently manufacture the first separator 70 and the second separator 80, and thus it is possible to reduce a production cost. Incidentally, it is allowed that the first separator 70 and the second separator 80 include different configurations from each other.

FIG. 5 shows an example of the second separator 80. FIG. 5 is a partially enlarged view that is for explaining an example of a stripe pattern of an adhesion layer 86 of the second separator 80. The second separator 80 shown in the figure includes a configuration the same as a separator in which the first separator 70 shown in FIGS. 2 to 4 is reversed. Therefore, the stripe pattern of the adhesion layer 86 is formed on both main surfaces of the second separator 80 shown in the figure, and a main surface positioned at a back side of the main surface shown in FIG. 5 corresponds to a configuration of the main surface shown in FIG. 4. In other words, configurations of the adhesion layer 86 and an adhesion layer not-formed area 88 of the herein-illustrated second separator 80 respectively correspond to the above-described adhesion layer 76 and the above-described adhesion layer not-formed area 78. Thus, a width W′ of the adhesion layer 86, width P′ of the adhesion layer not-formed area 88, and an angle α′ defined by the adhesion layer 86 and the long side of the main surface of the second separator 80 respectively correspond to the width W of the adhesion layer 76, the width P of the adhesion layer not-formed area 78, and the angle θ defined by the adhesion layer 76 and the long side of the main surface of the first separator 70. However, as shown in FIG. 4 and FIG. 5, an angle θ2 of the adhesion layer 86 with respect to the winding axis WL direction in a reference direction (right direction) is different from the above-described angle θ1. Incidentally, a range of an angle in which the above-described angle θ2 can be set is similar to a range in which the above-described angle θ1 can be set, and is not particularly restricted when a value of the angle θ2 is different from a value of the angle θ1.

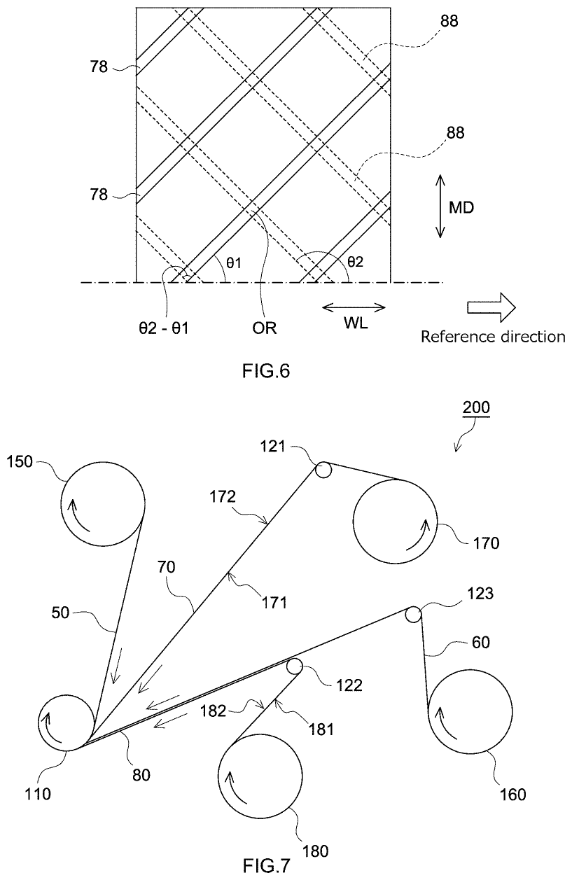

FIG. 6 is a view that is viewed from a flat side surface (wide-width surface) of the wound electrode assembly 20, and that schematically shows an overlap with the stripe pattern of the main surface of the first separator 70 and the stripe pattern of the main surface of the second separator 80, while the positive electrode 50 or negative electrode 60 are sandwiched by both main surfaces being opposed to each other. Incidentally, for the sake of explanation, the stripe pattern of the first separator 70 is shown by a solid line and the stripe pattern of the second separator 80 is shown by a broken line. In addition, for the sake of explanation, elements other than the first separator 70 and the second separator 80 are omitted in FIG. 6. As shown in FIG. 6, when the wound electrode assembly 20 is viewed from the flat side surface of the wound electrode assembly 20, an overlap area OR is generated on which the adhesion layer not-formed area 78 of the first separator 70 and the adhesion layer not-formed area 88 of the second separator 80 are overlapped.

The adhesion layer not-formed areas 78, 88 are overlapped on the overlap area OR, and thus a reaction force generated on the overlap area by loading a confining pressure to the wound electrode assembly 20 becomes smaller than a reaction force generated on an area where the adhesion layers 76, 86 are overlapped. For example, if the angles of the adhesion layers with respect to the winding axis on 2 sheets of separators are the same, the overlap area OR happens to be generated linearly along a direction in which the stripe pattern extends. As the result, a variation in reaction forces tends to be caused easily, and thus it might cause that appropriate adjustment on the confining pressure becomes difficult. Thus, in the herein disclosed wound electrode assembly 20, the angle θ1 of the first separator 70 defined by the adhesion layer 76 and the winding axis WL and the angle θ2 of the second separator 80 defined by the adhesion layer 86 and the winding axis WL are different from each other. By the configuration, the overlap areas OR can be dotted regularly, and thus it is possible to mitigate the variation in the reaction forces with respect to the confining pressure.

From a perspective of making each area size of overlap areas OR be smaller so as to further mitigate the variation in the reaction forces with respect to the confining pressure, a difference between the angle θ1 of the first separator 70 defined by the adhesion layer 76 and the winding axis WL and the angle θ2 of the second separator 80 defined by the adhesion layer 86 and the winding axis WL (θ2−θ1, because θ2>θ1 in FIG. 6) is preferably equal to or more than 40° and not more than 140°, further preferably equal to or more than 45° and not more than 135°, furthermore preferably equal to or more than 60° and not more than 120°, or in particular preferably equal to or more than 75° and not more than 105°.

In addition, from a perspective of making the area size of the whole of overlap area OR be smaller so as to further mitigate the variation in the reaction forces with respect to the confining pressure, the rate of the main surface of the first separator 70 covered by the adhesion layer 76 and the rate of the main surface of the second separator 80 covered by the adhesion layer 86 are preferably equal to or more than 50% and not more than 90%, or further preferably equal to or more than 60% and not more than 80%.

One aspect of the herein disclosed manufacturing method of the wound electrode assembly 20 could include a preparation step in which the elongated first separator 70, including the adhesion layer 76 located on both main surfaces in the stripe patterns with predetermined pitches, and the elongated second separator 80, including the adhesion layer 86 located on both main surfaces in the stripe patterns with predetermined pitches, are prepared. In addition, it could include a winding step in which the elongated negative electrode 60, the elongated positive electrode 50, the first separator 70, and the second separator 80 are stacked to make the first separator 70 be arranged between the negative electrode 60 and the positive electrode 50 and to make the second separator 80 be arranged on an outermost layer. In addition, the winding step includes winding the resultant (the stack including the negative electrode 60, the positive electrode 50, the first separator 70, and the second separator 80) around the winding axis as the center in the longitudinal direction.

In the preparation step, the above-described first separator 70 and the above-described second separator 80 are prepared. The first separator 70 and the second separator 80 can be manufactured by a well-known method. As the manufacturing method of the first separator 70, for example, an elongated porous resin base material to be the base material layer 72 is prepared. In a case of forming the ceramic layer 74, for example, this porous resin base material might be coated with a ceramic layer forming slurry that contains an inorganic particle and then the resultant might be dried.

Then, a coating liquid, containing an adhesion component and a solvent to form the adhesion layer 76, is prepared and then applied to coat the porous resin base material (base material layer 72) or the ceramic layer 74. At that time, the coating liquid is applied to coat at predetermined pitches so as to form the stripe pattern. In addition, at that time, coating is performed with an inclination at a desired angle along the long side of the main surface, in other words, with respect to the longitudinal direction. A suitable range of the angle as described above is similar to the above-described range of the angle θ. This kind of coating can be performed, for example, by using a roll coater, or the like, while the roll coater includes a gravure roll including an oblique groove with respect to a rotation direction. By drying the coating liquid used for coating, it is possible to form the adhesion layer 76 and to obtain the first separator 70. Incidentally, the manufacturing method of the second separator 80 might be similar to the first separator 70. In addition, the second separator 80 might include a stripe pattern the same as the first separator 70. Furthermore, the first separator 70 and the second separator 80 might be separators including the same configuration.

The winding step includes stacking the positive electrode 50, the negative electrode 60, the first separator 70, and the second separator 80. At that time, arrangement is performed to make the first separator 70 be arranged between the positive electrode 50 and the negative electrode 60, and to make the second separator 80 be one of the outermost layers (in other words, lowermost layer or uppermost layer). In other words, the positive electrode 50 or the negative electrode 60 is arranged between the first separator 70 and the second separator 80. The positive electrode 50, the negative electrode 60, the first separator 70, and the second separator 80 are stacked one on another to match respective orientations in the longitudinal direction.

In addition, at that time, the positive electrode 50, the negative electrode 60, the first separator 70, and the second separator 80 are stacked to make an angle of the adhesion layer 76 with respect to a predetermined direction (the reference direction) in the width direction (corresponding to a later-described winding axis direction) orthogonal to the longitudinal direction of the first separator 70 on the main surface of the first separator 70 and an angle of the adhesion layer 86 of the second separator 80 with respect to the predetermined direction (the reference direction) on the main surface of the second separator 80, which sandwiches the negative electrode 60 or the positive electrode 50 with the main surface of the first separator 70 and is oppose to the main surface of the first separator, be different from each other. A suitable range of the difference between the angle of the adhesion layer 76 of the first separator 70 and the angle of the adhesion layer 86 of the second separator 80 is similar to the above-described difference between the angle θ1 defined by the adhesion layer 76 of the first separator 70 and the winding axis WL and the angle θ2 defined by the adhesion layer 86 of the second separator 80 and the winding axis WL.

In the winding step, furthermore, the above stacked positive electrode 50, negative electrode 60, first separator 70, and second separator 80 are wound in the longitudinal direction with the winding axis treated as the center, to make the second separator 80 be the outermost surface. The winding method can be performed in accordance with a conventionally known method, and can be performed, for example, with a winding core treated as the center.

FIG. 7 is a schematic view that shows an example of a configuration of a winding apparatus 200 used for the manufacturing method of the wound electrode assembly in accordance with one embodiment. The winding apparatus 200 shown in FIG. 7 includes a winding core 110, rolls 121, 122, 123, a positive electrode roll 150, a negative electrode roll 160, a first separator roll 170, and a second separator roll 180. The positive electrode roll 150, the negative electrode roll 160, the first separator roll 170, and the and second separator roll 180 are respectively configured to be wound so as to be capable of continuously supplying the positive electrode 50, the negative electrode 60, the first separator 70, and the second separator 80, respectively.

Regarding an embodiment shown in FIG. 7, the positive electrode 50, the negative electrode 60, the first separator 70, and the second separator 80 are stacked one on another on the winding core 110. However, the present disclosure is not restricted to this, the positive electrode 50, the negative electrode 60, the first separator 70, and the second separator 80 might be stacked one on another and then the resultant might be supplied to the winding core 110. A configuration of the winding core 110 might be similar to a conventionally known winding core that is used for this kind of technique.

Although the rolls 121, 122, 123 are used for tension adjustments of the positive electrode 50, the negative electrode 60, the first separator 70, and the second separator 80 supplied to the winding core 110, change of a supply passage, or the like, they are not essential configurations. In addition, a number of the rolls can be adjusted arbitrarily, and thus is not particularly restricted.

In a suitable example, as the first separator roll 170 and the second separator roll 180, the same separator rolls are used. The separator roll as described above includes an oblique stripe pattern in which adhesion layers are formed on both main surfaces at predetermined angles with respect to the long side extending in the longitudinal direction. Thus, a wound inward surface 171 of the first separator 70 and a wound inward surface 181 of the second separator 80 include the same stripe pattern. In addition, a wound outward surface 172 of the first separator 70 and a wound outward surface 182 of the second separator 80 include the same stripe pattern. In that case, by arranging to make the wound inward surface 171 of the first separator 70 and the wound inward surface 181 of the second separator 80 be opposed to each other to sandwich the positive electrode 50 or the negative electrode 60, or by arranging to make the wound outward surface 172 of the first separator 70 and the wound outward surface 182 of the second separator 80 be opposed to each other to sandwich the positive electrode 50 or the negative electrode 60, it is possible to differ the angles of the stripe patterns with respect to a predetermined direction on those opposed surfaces. In FIG. 7, the wound inward surface 171 of the first separator 70 and the wound inward surface 181 of the second separator 80 are stacked one on another to be opposed to each other while sandwiching the negative electrode 60. This kind of superimposition with the first separator 70 and the second separator 80 can be implemented, for example, as shown in FIG. 7, by a convenient method that makes a direction in which the first separator 70 is supplied from the first separator roll 170 (counterclockwise direction in FIG. 7) and a direction in which the second separator 80 is supplied from the second separator roll 180 (clockwise direction in FIG. 7) be opposite directions to each other.

Incidentally, the herein disclosed manufacturing method of the wound electrode assembly 20 can include another step. For example, it can include a press step for pressing, after the positive electrode 50, the negative electrode 60, the first separator 70, and the second separator 80 are superimposed and then wound, the wound resultant from a direction orthogonal to a winding axis. By performing press as described above, it is possible to manufacture the wound electrode assembly formed in a flat shape. Incidentally, the press step can be performed by a conventionally known method.

Below, as one embodiment of the battery including the herein disclosed wound electrode assembly 20, a configuration of the nonaqueous electrolyte secondary battery 100 will be described.

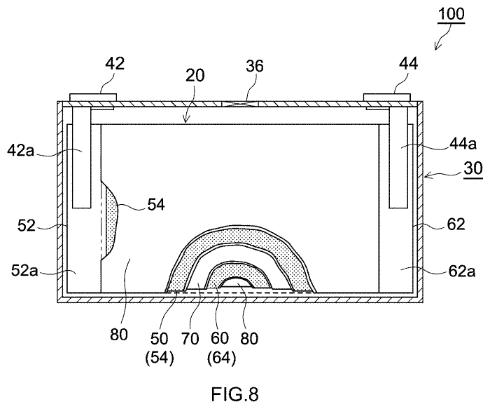

FIG. 8 is a cross section view that schematically shows a configuration of the nonaqueous electrolyte secondary battery 100 in accordance with one embodiment. The nonaqueous electrolyte secondary battery 100 is a square-shaped sealed battery constructed by accommodating the herein disclosed wound electrode assembly 20 and the nonaqueous electrolyte (not shown) inside the battery case 30. Here, the nonaqueous electrolyte secondary battery 100 is a lithium ion secondary battery. In addition, here, the wound electrode assembly 20 is formed in a flat shape. The battery case 30 includes a positive electrode terminal 42 and a negative electrode terminal 44 that are for outside connection. In addition, a thin-walled safety valve 36 is provided that is set to release an internal pressure of the battery case 30 when the internal pressure is increased to a predetermined level or more. Furthermore, the battery case 30 is provided with an injection port (not shown) for injecting the nonaqueous electrolyte. It is preferable for a material of the battery case 30 to use a metal material that has a high strength property, has lightweight, and has a good thermal conductivity. As this kind of metal material, it is possible to use, for example, aluminum, steel, or the like.

As shown in FIG. 8, a positive electrode electrical collector plate 42a is joined to the positive electrode current collector exposed part 52a of the wound electrode assembly 20, and a negative electrode electrical collector plate 44a is joined to the negative electrode current collector exposed part 62a. The positive electrode electrical collector plate 42a is electrically connected to the positive electrode terminal 42 for the outside connection, so as to implement conduction between the inside and the outside of the battery case 30. Similarly, the negative electrode electrical collector plate 44a is electrically connected to the negative electrode terminal 44 for the outside connection, so as to implement conduction between the inside and the outside of the battery case 30. Incidentally, between the positive electrode terminal 42 and the positive electrode electrical collector plate 42a, or between the negative electrode terminal 44 and the negative electrode electrical collector plate 44a, a current interrupt device (CID) might be disposed.

As for the nonaqueous electrolyte, it is possible to use one electrolyte similar to a conventional lithium ion secondary battery, and, for example, it is possible to use a nonaqueous electrolyte in which a supporting salt is contained in an organic solvent (nonaqueous solvent). As for the nonaqueous solvent, it is possible to use an aprotic solvent, such as carbonates, esters, and ethers. Among them, it is possible to suitably use the carbonates, for example, ethylene carbonate (EC), diethyl carbonate (DEC), dimethyl carbonate (DMC), ethyl methyl carbonate (EMC), or the like. Alternatively, it is possible to preferably use a fluorine type solvent of fluorinated carbonate, or the like, such as monofluoroethylene carbonate (MFEC), difluoroethylene carbonate (DFEC), monofluoromethyl difluoromethyl carbonate (F-DMC), and trifluoro dimethyl carbonate (TFDMC). It is possible to use the nonaqueous solvent as described above, by selecting one kind or suitably combining 2 or more kinds. As the supporting salt, for example, it is possible to suitably use a lithium salt, such as LiPF₆, LiBF₄, and LiClO₄. A concentration of the supporting salt is not particularly restricted, but is preferably to be approximately equal to or more than 0.7 mol/L and not more than 1.3 mol/L.

Incidentally, the above-described nonaqueous electrolyte might contain a component other than the above described nonaqueous solvent and supporting salt if the effect of the present technique is not significantly spoiled, and might contain, for example, various additive agents, such as a gas generating agent, a coating film forming agent, a dispersing agent, and a thickening agent.

The nonaqueous electrolyte secondary battery 100 can be used for various purposes. As a particular purpose, it is possible to use it for a portable power supply of personal computer, portable electronic equipment, portable terminal, or the like; a power supply for driving automobiles of battery electric vehicle (BEV), hybrid electric vehicle (HEV), plug-in hybrid electric vehicle (PHEV), or the like; a storage battery of small electric power storing apparatus, or the like; or the like, and the power supply for driving automobiles is preferable among them. The nonaqueous electrolyte secondary battery 100 can be used in a battery pack form configured by typically connecting plural batteries in series and/or parallel.

Incidentally, the square-shaped nonaqueous electrolyte secondary battery has been explained as one example, but the present disclosure is not restricted to this. For example, it can be configured as a coin-type nonaqueous electrolyte secondary battery, a button-type nonaqueous electrolyte secondary battery, a cylindrically shaped nonaqueous electrolyte secondary battery, or a laminate-case-type nonaqueous electrolyte secondary battery. In addition, the herein disclosed nonaqueous electrolyte secondary battery can be configured as a nonaqueous electrolyte secondary battery other than the lithium ion secondary battery, based on a well-known method.

Above, about the herein disclosed technique, a detailed description for a specific example has been given, but these are merely illustrations, and thus do not restrict the scope of claims. The herein disclosed technique contains ones in which the above-described specific examples are variously deformed or changed.

What is claimed is:

1. A flat-shaped wound electrode assembly, comprising:
an elongated negative electrode;
an elongated positive electrode;
an elongated first separator; and
an elongated second separator, wherein
the negative electrode, the positive electrode, the first separator, and the second separator are stacked and wound around a winding axis in a longitudinal direction,
the first separator is arranged between the negative electrode and the positive electrode,
the second separator is arranged on an outermost surface of the wound electrode assembly,
on each of both main surfaces of the first separator and both main surfaces of the second separator, an adhesion layer is located in stripe patterns with predetermined pitches, and
when viewed from a flat side surface of the wound electrode assembly, an angle of the adhesion layer of the first separator in a predetermined direction of the winding axis direction with respect to the winding axis on the main surface of the first separator is different from an angle of the adhesion layer of the second separator in the predetermined direction of the winding axis direction with respect to the winding axis on the main surface of the second separator opposed to the main surface of the first separator and sandwiching the negative electrode or the positive electrode with the main surface of the first separator.

2. The wound electrode assembly according to claim 1, wherein
a difference between the angle of the adhesion layer of the first separator with respect to the winding axis and the angle of the adhesion layer of the second separator with respect to the winding axis is equal to or more than 40° and not more than 140°.

3. The wound electrode assembly according to claim 1, wherein
each of a rate of the main surface of the first separator covered by the adhesion layer and a rate of the main surface of the second separator covered by the adhesion layer is equal to or more than 50% and not more than 90%.

4. A battery, comprising the wound electrode assembly according to claim 1.

5. A method for manufacturing a wound electrode assembly, comprising:
a preparation step for preparing an elongated first separator that comprises an adhesion layer located on both main surfaces in stripe patterns with predetermined pitches, and an elongated second separator that comprises an adhesion layer located on both main surfaces in stripe patterns with predetermined pitches; and
a winding step for stacking an elongated negative electrode, an elongated positive electrode, the first separator, and the second separator to arrange the first separator between the negative electrode and the positive electrode and to arrange the second separator on an outermost layer and winding the stack around a winding axis in a longitudinal direction, wherein
the winding step includes stacking the negative electrode, the positive electrode, the first separator, and the second separator so as to make an angle of an adhesion layer of the first separator with respect to a predetermined direction of a width direction orthogonal to a longitudinal direction of the first separator on a main surface of the first separator difference from an angle of an adhesion layer of the second separator with respect to the predetermined direction on a main surface of the second separator that is opposed to the main surface of the first separator and sandwiches the negative electrode or the positive electrode with the main surface of the first separator.

6. The method according to claim 5, wherein
the stripe pattern of the first separator and the stripe pattern of the second separator are the same.
